(19) United States
(12) Patent Application Publication
(10) Pub. No.: US 2023/0377443 A1
(43) Pub. Date: Nov. 23, 2023

(54) PERSONAL PROTECTIVE EQUIPMENT SYSTEMS AND METHODS FOR DETECTING PROXIMITY EVENTS

(71) Applicant: EATON INTELLIGENT POWER LIMITED, Dublin, 4 (IE)

(72) Inventors: Daniel ZUCCHETTO, Dublin (IE); Julia O'CONNELL, Dublin, Ballsbridge (IE); Keith NOLAN, Mullingar, Westmeath (IE)

(21) Appl. No.: 18/247,580

(22) PCT Filed: Oct. 1, 2021
(86) PCT No.: PCT/EP2021/077116

§ 371 Date: Mar. 31, 2023

Related U.S. Application Data
(60) Provisional application No. 63/087,646, filed on Oct. 5, 2020.

(51) Int. Cl. G08B 21/18

(52) U.S. Cl. CPC G08B 21/182

(57) ABSTRACT

A personal protective equipment device is provided herein. The personal protective equipment device includes a processor and a memory, and the processor is configured to: transmit an advertising signal to other personal protective equipment devices; receive advertising signals from the other personal protective equipment devices when the personal protective equipment device and the other personal protective devices interact with each other; determine, based upon an intensity of the received signals, that one of the received signal intensities is above a predetermined threshold; identify the other personal protective equipment device associated with the received signal above the predetermined threshold; identify the interaction between the personal protective equipment device and the other personal protective equipment device associated with the received signal above the predetermined threshold as a proximity event; and store the proximity event in the memory.

### BACKGROUND OF THE DISCLOSURE

The field of the disclosure relates generally to computer-implemented personal protective equipment (PPE) monitoring systems, and more specifically, to an intelligent PPE device that is configured to monitor user biometrics, such as pulse and temperature, to detect removal of the PPE as well as other status conditions related to the health and safety of the equipment user.

A variety of different types of personal protective equipment (PPE) exist and may be required by a host of healthcare, industrial, utility, and trade workers to provide a degree of protection from known risks in the hazardous environments in which work is performed. When utilized with appropriate and detailed safety protocols defining the specific items of PPE (e.g., protective suit, faceshield, gloves, etc.) needed for certain environments or for certain tasks within such environments, and also for the proper use thereof, enhanced worker safety in otherwise hazardous environments can be desirably realized.

Challenges remain, however, in effectively overseeing the proper use of PPE by personnel in a hazardous environment. While conscientious and well-trained workers will follow PPE protocols, occasional carelessness and mistakes can be expected, with potentially severe consequences. Also, the personal wellness of workers may contribute to carelessness and mistake by certain workers. In some cases, personal wellness may be part of the safety protocols in place to discourage unhealthy employees from performing certain tasks. An ill worker may lack the same focus as a healthy worker or be subject to distractions that do not ordinarily exist in performing a hazardous task, but to some extent the personal wellness of workers is entirely subjective and workers may not be cognizant of health issues or may overestimate their ability to overcome such issues. Achieving a healthy workforce and compliance with applicable PPE protocols is therefore an ongoing concern from the safety perspective, and intentional or unintentional violations of PPE protocols that compromise the desired safety protocols can often be difficult to detect across a number of workers in different areas performing different tasks.

At least some computer-implemented monitoring systems exist for monitoring the health and safety of workers, but many such systems lack the capability to detect specific PPE compliance issues, proximity issues, and wellness issues associated with particular individuals in the group. Likewise, at least some known PPE monitoring systems lack the capability to detect removal of PPE by workers, potential onset of illness during work hours, and other status events related to the health and safety of workers, such as, for example, falls and other accidents occurring during work hours and while workers are attired in PPE. Improvements are therefore desired.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a schematic illustration of a PPE monitoring system architecture according to an exemplary embodiment of the present disclosure.

FIG. 2 is a flow diagram illustrating a flow of data between components of the system of FIG. 1.

FIG. 3 is a flow diagram illustrating an example process for determining proximity events between PPE devices of the PPE monitoring system shown in FIG. 1.

FIG. 4 is a schematic diagram of a client computing device that may be used in the PPE monitoring system shown in FIG. 1.

FIG. 5 is a schematic diagram of a server computing device that may be used in the PPE monitoring system shown in FIG. 1.

### DETAILED DESCRIPTION OF THE DISCLOSURE

In order to understand the inventive concepts described below to their fullest extent, set forth below is a discussion of the state of the art and certain longstanding problems pertaining to personal wellness and PPE compliance, followed by systems and methods addressing longstanding problems in the art.

It is a practical reality, in certain industries, that exposure of at least some workers to hazardous, or potentially hazardous, working conditions cannot be avoided. As one example, workers in the electrical industry, and more specifically those working in and around electrical power systems, must be trained in the appropriate use of PPE to mitigate possible electrical hazards with which they may be faced.

Aside from hazards associated with electrical shock and electrocution, electrical arc flash incidents are of particular concern. Electrical arcing, or current flow between two or more separated energized conductors, may be experienced when installing, servicing, and maintaining electrical systems. Arcing may occur from electrical fault conditions and can release significant amounts of concentrated radiant energy at the point of arcing in a fraction of a second, resulting in high temperatures that may burn persons exposed to them. Additionally, arcing conditions may produce pressure blasts that are more than sufficient to knock nearby workers off their feet, and shrapnel may be generated by the blast.

Arcing in an electrical power system may suddenly arise in various scenarios that cannot be reliably predicted. For example, insulation failure of components used in electrical systems, including but not limited to cables that interconnect electrical components and equipment may precipitate arcing, as well as a build-up of dust, impurities and corrosion on insulating surfaces. Sparks generated during operation of circuit breakers, during replacement of fuses, and closing electrical connections on faulted lines may also produce an arc. Damage to components and equipment from rodents and pest infestations may result in arcing conditions. Finally, arcing may be the result of unpredictable scenarios of human error such as dropping a tool onto energized conductors, accidental or incidental contact with energized components or equipment, and improper work procedures or mistake in following a procedure to completing a task.

Accordingly, PPE that is adequate or sufficient to provide at least a minimum level of protection to persons against potential electrical hazards has been developed for practically the entire human body, such as for example, electric shock, arc flash and arc blast. Persons wearing such personal protective equipment may be reasonably protected from incidental contact with energized conductors and potentially hazardous arc flash incidents and such PPE may avoid or reduce the likelihood of serious injury if such an arc flash incident occurs. Examples of PPE items may include a hard hat, a face shield, a flame resistant neck protector, ear protectors, a Nomex™ suit, insulated rubber gloves with leather protectors, and insulated leather footwear. Insulated tools may also be provided to complete certain tasks. Such personal protective equipment may be fabricated from various materials to provide, among other things, thermal insulation protection to prevent severe burns to human flesh during high temperature arcing conditions, and to mitigate pressure blasts and shrapnel to avoid life-threatening wounds to a worker's head and torso if arcing conditions were to occur. Different grades of PPE are available to protect against varying degree of risk presented. For example, in the case of electrical fuses that need replacement under energized circuit conditions, fuses of higher electrical ratings may pose a greater risk than fuses of lower electrical ratings, and different amounts or types of personal protective equipment may be required for replacing one fuse, for example, than for replacing another fuse.

Similar considerations exist for other types of hazardous environments rendering similar PPE items desirable for use such as, for example only, petroleum refineries, petrochemical plants, grain silos, wastewater and/or treatment facilities, or other industrial facilities in which sustained or volatile conditions in the ambient environment may be present and may present a heightened risk of fire or explosion and/or a potential exposure to caustic chemicals and substances. Various different grades of PPE are available, which may be similar to or different from the grades of PPE designed for electrical hazards, to meet different risks posed by different situations.

In the healthcare environment, PPE items have been used to protect doctors and nurses in the treatment of patients having conditions that present health risks to healthcare providers when performing certain procedures. Different grades of PPE are available to meet different risks posed by different healthcare procedures. Paramedics, Emergency Medical Technicians (EMTs), Law Enforcement Offices, Firefighters and other emergency responders, as well as military personnel also have PPE items and protocols for responding to certain situations.

Wherever needed, PPE items are subject to appropriate and detailed safety protocols defining their use. Such protocols may detail specific items of PPE (e.g., protective suit, faceshield, gloves, etc.) needed for certain environments or for certain tasks within such environments, processes for obtaining the proper grade of PPE where multiple grades are available, processes for when such PPE items are required to be worn, processes for how such PPE items must be adorned and used, and processes for how PPE should be removed and cleaned for subsequent use. A number of practical challenges exist, however, in effective oversight of the proper use of PPE by personnel in a hazardous environment. Conscientious and well-trained workers will dutifully follow PPE protocols, but occasional misunderstanding, carelessness, and mistake may nonetheless occur with potentially severe consequences. Ensuring compliance, or detecting non-compliance, with applicable PPE protocols is therefore an ongoing concern.

For instance, a worker may have access to the proper PPE items to mitigate safety risks, but may nonetheless improperly use a PPE item in a non-compliant and therefore risky way. In the case of a faceshield for example, a user may temporarily remove his or her faceshield in a hazardous location, and present much risk in doing so without necessarily realizing it, or forget to put the faceshield on at the required point of the procedure. Such incidents are very difficult to detect in order to allow an overseer of management of the facility to take proactive steps such as discipline or additional training for affected workers that are violating PPE protocols. Likewise, in the case of a positionable faceshield that is selectively operable in an “up” position away from one's face or a “down” position covering one's face, the faceshield may inadvertently be in the wrong position (i.e., up instead of down) when performing a hazardous task, again presenting risk without the worker necessarily realizing it. Such incidents too tend to be very difficult to detect, and management therefore generally lacks opportunity to take appropriate actions to address concerning compliance issues, especially for workers performing tasks alone.

While a protocol for some procedures require a group of persons to perform tasks together such that any PPE non-compliance can be witnessed and reported by another worker, this is not always a reliable safeguard. Different workers may approach compliance issues from various perspectives that render compliance assessment subjective rather than objective. Certain workers may be reluctant to report, or may failure to recognize or understand that a compliance violation had actually occurred. In a rarer case, a worker or a group of workers may knowingly disregard aspects of a protocol that they do not appreciate.

Unless reliably and consistently detected, intentional or unintentional violations of PPE protocols may occur indefinitely to undermine important safety considerations, and across a number of workers in different areas performing different tasks the challenges to oversee PPE compliance and detect non-compliance are multiplied. Some smart, computer-implemented monitoring systems exist in the industrial realm that intelligently incorporate sensors in items of PPE to create a greater degree of situational awareness of worker safety across groups of workers, but known systems of this type generally lack a focus on evaluating specific PPE compliance issues of the type described above.

The onset of the global “COVID-19” pandemic has raised new concerns and demands for the proper use of PPE and compliance with PPE protocols in environments that prior to COVID-19 were generally not considered “hazardous” in a manner that demonstrated a prior need for PPE. Such environments include areas of industrial facilities that are isolated from conventionally defined hazards, healthcare facilities and areas of healthcare facilities that were not previously considered to present high risk scenarios, elementary schools, middle schools, high schools, colleges and universities, offices and businesses of all types, shops and retail establishments, dining establishments, churches, entertainment venues, etc. Desirable PPE items are therefore prolifically present in these environments, but still subject to improper or non-compliant use in ways that are difficult to predict or control.

In the COVID-19 era, individual personal wellness is an important consideration to ensure that no transmission of the virus occurs to nearby persons. In general, persons have COVID-19 symptoms are strongly advised not to interact with other persons, but in some instances a person may have symptoms without necessarily realizing it. Temperature checks upon entry to an area are sometimes conducted as a course filter for screening purposes for personal entry to a space where other persons are present, but such temperature checks are limited in important aspects. Persons who passed the temperature check upon entry may develop a fever or other symptoms after the temperature check was made. In certain cases COVID-19 illness or other illnesses may rapidly develop and may suddenly impair a person considerably, so early detection of symptoms can be important but are unfortunately rare. These considerations may be of particular importance for persons that happen to be operating in a conventionally hazardous environment when a debilitating illness or health condition occurs. Existing COVID-19 protocols and electronic tools are generally reactive by nature rather than being proactive in such aspects.

Social distancing and masking are other another important consideration to address risks posed by other persons possibly having the COVID-19 virus or other conditions that can be contagiously spread or communicated to others. Faceshields may suffice for the mask requirement, but for the reasons above are subject to misuse that can defeat the virus protection desired. Proximity sensing and contact tracing technologies have emerged to monitor social distancing aspects and collect information that may be helpful to maintain an outbreak of illness, but they are disadvantaged in some aspects for certain hazardous environments. For instance, smart-phone based contact tracing apps are of no aid in environments wherein smart phones are prohibited. Known contact tracing apps also operate independently of PPE systems and lack capability to assess wellness in a proactive manner.

For the reasons above, effective PPE monitoring systems are needed to more intelligently address PPE compliance with protocols that are COVID-19 related and non-COVID-19 related but nonetheless implicate important wellness and PPE compliance concerns to varying degrees.

Example processor-based sensor systems are described herein that include embedded sensor technology in wearable personal protective equipment devices. Combinations of sensors are provided in intelligent wearable PPE items worn by different persons to be monitored. The intelligent wearable PPE items are configured to connect and communicate with one another in a population of persons wearing the intelligent PPE items and also to a remote centralized system that aggregates data for review, analysis, and oversight or individual personal wellness and PPE compliance issues in an objective and reliable manner allowing proactive management of health and safety risks in a community of persons.

The combination of sensors provided in each intelligent wearable PPE item are operable in combination to provide signal inputs that may be processed and analyzed to collectively assess the wellness and physical position and/or orientation of the person wearing each intelligent PPE item, sense a proximity of each person wearing an intelligent PPE item to another person wearing an intelligent PPE item, assess compliant use of the PPE item by each wearer, provide feedback indicators to sensed parameters to persons wearing intelligent PPE items, record contact tracing information, and output data and information to a remote device that can be accessed by overseers via informational dashboard displays. For example, the dashboard displays may display logged proximity events wherein one or more people wearing PPE come within a certain distance of each other. Proactive steps may be taken by overseers to quickly and proactively respond to detected issues to minimize risks presented to a community of persons wearing the intelligent PPE items.

In a contemplated example, an intelligent wearable PPE item according to the present disclosure may be provided in the form of a headband equipped with a faceshield, although other wearable PPE items may likewise be provided in addition to or in lieu of headbands and faceshields as desired with similar intelligent features. The headband includes pockets or receptacles to receive one or more sensor assemblies each including a processor receiving inputs from a set of biometric sensors such as an oximetry sensor, an inertial measurement unit, and a temperature sensor to assess aspects of wellness of a person wearing the headband and faceshield. The sensors may be strategically located in different locations on the headband or on the faceshield proximate particular portions of a user's head to monitor health and wellness parameters, and the headband including the sensors is fabricated to be lightweight and adjustable in size to accommodate a variety of different users in a comfortable manner. Wire management features and the like may be built-in to the headband structure allowing the sensors to interconnect.

By virtue of the set of biometric sensors that are located proximate the head of wearer when the headband and faceshield is worn, the sensors can detect wellness of the wearer and an onset of COVID-19 or other health-related symptoms (e.g., fever or shortness of breath) and other health impairments that could present risk to others or affect an ability of the person to successfully complete hazardous tasks. The set of biometric sensors can also utilized to determine wellness aspects such as whether a person wearing the headband and faceshield has fainted or has fallen down and needs assistance, and PPE compliance aspects such as whether a person has removed the headband or faceshield or is otherwise using them in an improper way that defeats desired safety objectives. Likewise, in at least some embodiments, removal of PPE may be detected, such as in response to changes in biometric data caused by or resulting from removal of PPE (e.g., temperature changes, blood oxygen level changes, and the like). Output signals may be generated by the processor to provide feedback signals to detected health conditions via activation of LED lights for example that may be observed by the wearer or other nearby persons. Activation of such lights may provide notice of personal health issues and possible risks that would otherwise not be detected by the persons wearing the intelligent PPE items. Wellness information and detected events may in some cases be recorded and stored by the processor some embodiments in a manner that ensures personal anonymity in the data collected and such information may be communicated to a remote system for system archiving, analysis and reporting purposes.

Also, in contemplated examples the headband and faceshield includes a low power communications device in the form of a Bluetooth transceiver that may communicate with other Bluetooth transceivers in wearable PPE items. Based on Received Signal Strength Indication (RSSI) considerations of the Bluetooth transceivers, the distance between the persons wearing the intelligent PPE items can be determined. Based on such RSSI considerations, when persons who are determined to be distanced by less than a predetermined amount (e.g., six feet) output signals may be generated by the processor in each PPE item to provide feedback signals to warn each person of a proximity violation that they can quickly correct. Proximity violation information or “proximity events” may be recorded by each processor to provide effective contact tracing when needed.

The sensor and monitoring system described herein may be equally applicable to any of the areas listed above, or other areas that present similar issues or concerns, which are deemed hazardous in a non-conventional way solely because of COVID-19 issues or other pandemic or epidemic outbreaks that compel a use of PPE and/or conventional areas deemed hazardous in a conventional way due to risks such as shock, blasts, impact, fire, explosion, chemical burns, and all sorts of undesirable exposure to potentially harmful elements.

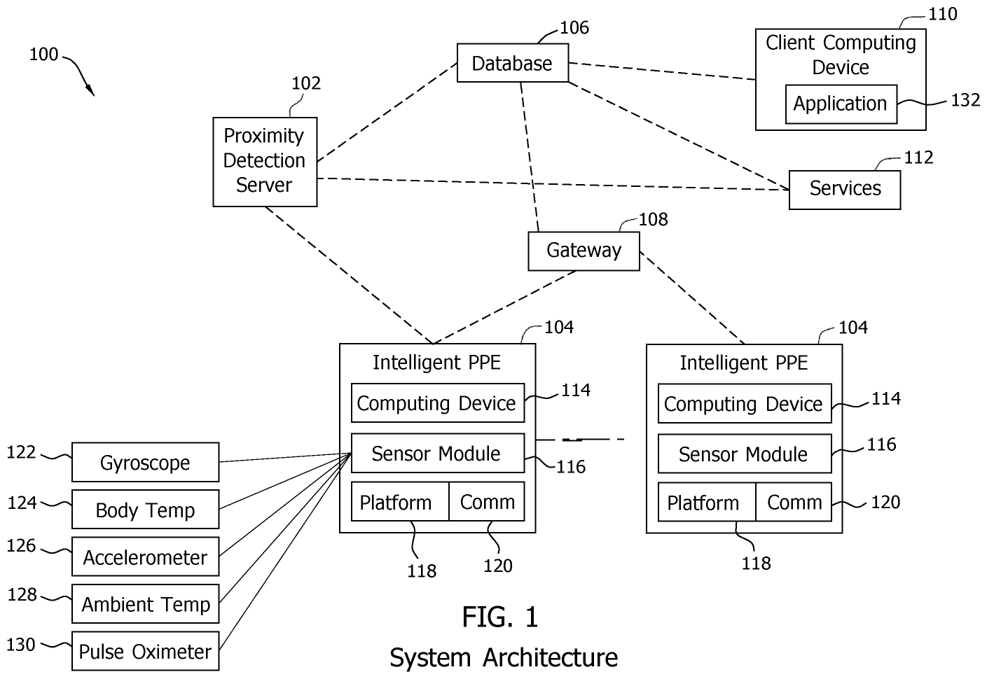

FIG. 1 is a schematic illustration of an exemplary architecture of a PPE monitoring system 100. The system 100, as shown, includes a remote server 102 in communication with intelligent personal protective equipment (PPE) devices 104, a database 106, a gateway 108, and a services module 112. In the illustrated embodiments, one remote server 102 is shown. However, in other embodiments, there are multiple remote servers 102 communicatively coupled together (e.g., in a fog computing or “cloudlet” environment). Further, in the illustrated embodiment, two PPE devices 104 are illustrated. However, in other embodiments, system 100 includes a plurality of PPE devices 104.

In the exemplary embodiment, each PPE device 104 is worn by different persons or “users” being monitored. The PPE devices 104 may include a headband and faceshield device, a mask, a suit, or any other suitable PPE or other types of wearable items with similar benefits. In some embodiments, PPE device 104 (e.g., including sensors 122-130 of sensor module 116) may be enclosed in a housing and configured to be clipped, attached, or otherwise coupled to a clothing item, including a PPE item, such as a suit, a headband and/or faceshield, of a user. For example, PPE device 104 may be clipped or attached to a shirt, pants, a faceshield, and the like. Similarly, PPE device 104 may, in at least some embodiments, be attached to a lanyard and/or a similar device, such as a badge reel, and worn on the person of a user.

Each PPE device 104 includes a processor-based control element shown as a “computing device” 114 in FIG. 1. As used herein, the term “processor-based” may refer to computers, processors, microprocessors, microcontrollers, microcomputers, programmable logic controllers, reduced instruction set (RISC) circuits, application specific integrated circuits and other programmable circuits, logic circuits, equivalents thereof, and any other circuit or processor capable of executing the functions described below. The above examples are exemplary only, and are thus not intended to limit in any way the definition and/or meaning of the term “processor-based device”.

In the illustrated example, the processor-based control in each PPE device 104 is implemented in a microcomputer or other processor 114, and a memory that stores executable instructions, commands, and control algorithms, as well as other data and information required to satisfactorily operate the system as explained below. The memory of the processor-based device may be, for example, a random access memory (RAM), although other forms of memory could be used in conjunction with RAM memory, including but not limited to flash memory (FLASH), programmable read only memory (PROM), and electronically erasable programmable read only memory (EEPROM). The computing devices 114 are powered by on-board power supplies such as batteries in each PPE device 104 which may be rechargeable in some embodiments.

Each computing device 114 receives signal inputs from sensors of a sensor module 116. For example, the sensors of the sensor module 116 may include a gyroscope 122, a body temperature sensor 124, an accelerometer 126, an ambient temperature sensor 128, and a pulse oximeter sensor 130, each monitoring various environmental, physiological, and/or physical parameters of the wearer when the PPE device 104 is being worn. As used herein, physiological and other health-related parameters may in some cases be generally referred to as “biometric” data, biometric parameters, or simply biometrics.

The pulse oximeter sensors 130 are configured to monitor blood oxygen saturation levels commonly referred to as SpO2 wherein ‘S’ indicates saturation, p indicates pulse, and O2 indicates oxygen. The sensors 130 in contemplated examples are known optical sensor devices that provide an Sp02 measurement, typically expressed as a percentage, that indicates how effectively a person is breathing and how well blood is being transported throughout the body. An average SpO2 reading for a normal, fit adult is 96%. The computing devices can accordingly monitor the sensors of sensor modules 116 and compare their outputs to predetermined thresholds (e.g., to assess wellness of a person in the SpO2 aspect).

The gyroscope 122 and the accelerometers 126 may include sensor devices that measure movement of the PPE item containing the PPE devices 104. Since the sensor modules 114 are in wearable PPE items, the sensors 122-130 of each sensor module 114 in turn measure the movement of a person when the PPE item is being worn. Accordingly, each PPE device 104 includes a set of sensor elements such as an accelerometer which measures velocity and acceleration, a gyroscope that measures rotation and rotational rate, and/or a magnetometer that establishes a directional heading of movement. The computing devices 114 receiving such measurements from the sensor modules 116 can therefore intelligently track the position and movement of the PPE item (and corresponding movement of a person) and look for unexpected measurements that may require alerts and notifications to be generated. For instance, measurements may reflect a short but sudden and unexpected acceleration that could indicate a fall or loss of consciousness of a worker, an impact or blast indicating an accident with possible injury, a worker that is unexpectedly running and may be in distress or responding to an emergency event, or other wellness-based events.

The sensor module 114 measurements may also be beneficially assessed to detect PPE compliance issues such as an unexpected lack of movement if a worker removes a wearable PPE item in an unauthorized manner and puts the item down. The measurements can also be calibrated to detect certain signatures corresponding to PPE movement and position relative to the person wearing it. For example, a PPE device 104 associated with a faceshield may be recognized by a respective computing device 114 in an “up” or “down” position and therefore can intelligently determine whether the faceshield is up or down and when it was changed from up to down or vice versa. The PPE devices 104 may also facilitate a detection of a person in an unauthorized location and other events of interest that may otherwise have gone undetected.

The body temperature sensor 124 may include any known temperature sensor, such as an infrared thermopile, that measures the body temperature of the person wearing the PPE item. Likewise, the ambient temperature sensor 128 may include any temperature sensor suitable for measuring an ambient temperature near the user proximate the user of a given PPE device 104.

Predetermined limits can be set for the computing devices 114 to measure body temperature and/or ambient temperature and confirm, for example, that the person has a normal temperature within a range of expected temperature, an elevated temperature (e.g., fever) above a normal temperature range corresponding to an illness, or a failure to record an expected temperature corresponding to a compliance event wherein the person is not wearing the PPE item. When applied to a faceshield, a temperature sensor 124 may also assist in determining whether the faceshield is in up or down position. The up position will generally be expected to fail measure the wearer's body temperature at all, while the down position will facilitate a body temperature measurement.

In combination, the sensors 122-130 provide seamless evaluation of personal wellness and PPE compliance monitoring in a sophisticated manner. The sensors 122-130 provide some redundancy in feedback signals that in combination can be used in a corroborating manner to intelligently confirm detection events or identify error conditions. For example, when the sensors 130 indicate normal Sp02 measurements, the sensors 122 and 126 indicate normal expected movement and position, and when the sensors 124 and 128 indicate expected temperatures they provide three different points of reference that the PPE items including the sensors are actually being worn by a person. Likewise, when the sensors 130 indicate no Sp02 measurements, the sensors 122 and 126 indicate no expected movement and position, and when the sensors 124 and 128 indicate no expected temperatures they provide three different points of reference that the PPE items including the sensors are not actually being worn.

As a further example, when the sensors 130 indicate normal Sp02 measurements, the sensors 122 and/or 126 indicate normal expected movement and position, and when the sensors 124 fail to measure body temperatures it can be deduced that a faceshield is in the up position away from the user's face. In this case, the other sensors may indicate that the PPE item is being worn or, stated another way, the other sensors may not indicate that PPE is not being worn. For a faceshield that does not have a positional up/down capability the same sensor outputs would indicate an error condition in the temperature sensors.

The sensors of sensor modules 116 in certain embodiments may be switched on an off by the computing devices 114 at periodic intervals to receive a measurements over time with reduced energy consumption and longer battery life. In another embodiment, one or more of the sensors of sensor modules 116 may be continuously operated if desired but with increased energy consumption and shorter battery life.

In the example shown, each PPE device 104 further includes a communications platform 118 and/or a communications module 120, such as a transceiver, configured for short-range wireless communication with one another via known Bluetooth standards and protocol. Such Bluetooth transceivers are continuously seeking to communicate with another Bluetooth device and accordingly whenever the communications module 120 is within signal range of another communications module 120, the two devices may recognize one another via unique IDs provided to each device. The communications modules 120 are relatively low power devices and promote longer battery life, although non-Bluetooth transceivers and communication protocols other than Bluetooth protocols are possible in other embodiments.

The communications modules 120 also allow aspects of PPE compliance to be evaluated. The IDs of each communications module 120 can be correlated to the type or grade of PPE items to which it is embedded. For instance, if a first communications module 120 corresponds to a Level 1 type of PPE item corresponding to a first and lower level or risk, if it detects a signal from a transceiver another communications module 120 that corresponds to a Level 3 type of PPE item that corresponds to a much higher level of risk, it can be deduced that one of the persons has an improper type/level of PPE for the area where the persons reside. In such a scenario a notification or an alert may be generated by a respective computing device 114. This case may also correspond to a person in an unauthorized location, and again a notification or alert can be generated.

The communications modules 120 may also allow proximity sensing of two persons each wearing the respective PPE items. In general, as the Bluetooth receivers operate they measure a Received Signal Strength Indicator (RSSI) level. Generally speaking, the closer the communications modules 120 are to one another the stronger the RSSI between them and as the distance between them increases the RSSI level will become weaker. In the calibration of the devices, the RSSI level can be a good indicator of proximity of two persons. If the RSSI level is below a certain limit at least a predetermined amount of distance between the two persons can be deduced, but as the RSSI level approaches or exceeds a predetermined limit it can be deduced that the two persons are too close to another. The RSSI limit may be determined to assess a 6 foot proximity limit to achieve desired distancing to reduce a possible transmission of COVID-19. Higher and lower proximity limits and settings are possible, however, to meet particular needs and achieve particular objectives.

If a proximity violation is detected (i.e., the two persons are too close to each other based on the RSSI values of the respective communications modules 120 data and information can be recorded by the processor for contract tracing purposes. The unique IDs of each transceiver can be correlated with specific individuals for contact tracing purposes to manage possible outbreaks or epidemics in the monitored locations.

Feedback indicators may also be provided for use by the persons wearing the PPE items. In contemplated embodiments feedback indicators may be one or more illumination elements that are operable to emit different colored light (e.g., red/green/blue (RGB) light emitting diodes (LEDs), or via different lighting elements each respectively providing a single color that are selectively illuminated to achieve desired color coded notifications to persons wearing the PPE items. In a simple example, an emitted red color may indicate a proximity violation or provide a warning of a possibly unwell person, while a green light indicates that proper distancing is being maintained or that a person being encountered is well. In further and/or alternative embodiments additional feedback elements such as audio elements or haptic elements may be provided to notify or alert the persons of detected issues. The feedback indicators may be positioned in any location on the PPE item they may recognized by sight, sound or tactile sensation in order to act accordingly in response.

It is understood that additional sensors may be provided to meet the needs of certain end uses and applications. For example, an electromagnetic field detector may be provided to assist an electrical worker. The electromagnetic field detector may sense a presence of a magnetic field induced by electrical current flow in a conductor and therefore may assist the worker in knowing whether or not a component or machinery in an electrical power system is “live” or energized when conducting a maintenance or service procedure. External temperature sensors and other environmental sensors may also be provided to assist workers in assessing risks in taking any particular action.

As further illustrated in FIG. 1, a Bluetooth gateway device 108 is within signal range of the PPE devices 104 to collect sensor data and information and any request or notification data from the PPE devices 104. The Bluetooth gateway device 108 then sends to the collected data and information to a remotely located computer server and/or database 106 storing information in database 106. In various embodiments, gateway 108 may include, as described elsewhere herein, a plurality of connected compute devices pooling processing, control, and storage resources, which in turn can communicate with a cloud environment. Accordingly, as used herein, in some cases, gateway 108 and/or PPE devices 104 may be referred to as “edge” or “cloudlet” devices.

Communication between PPE devices 104 and gateway 108 may occur by way of any suitable wireless technology, such as Bluetooth or Wi-Fi. In some embodiments, there may be any number of cloudlet or edge computing devices implemented to increase system reliability and/to distribute communication and processing loads within the network. Such edge computing devices may thus be considered an extension of the cloud computing environment within a workplace, forming all or a portion of a “fog” infrastructure in which such devices exist.

In some embodiments, connection by PPE devices 104 to such edge or cloudlet devices may be intermittent, in which case PPE devices 104 may store, in local memory, collected data. Data stored in this manner may be forwarded or uploaded to cloud devices when connection to the cloud becomes available. As a result, floor managers and/or other workers may be enabled to view, in real-time, up-to-date status of all PPE users. If an alert occurs, there is, as described herein, local feedback available for the user of the PPE and an alert may also be triggered, such as by way of a graphical user interface available to a floor manager or another worker, indicating that the alert was triggered, the type of alert, the location of the employee, and the like. Likewise, an alert may be triggered on the person of the worker, such as a haptic or audible alert, a visual alert, and the like.

The stored data and information may be accessed through computer devices, such as services devices 112, for review in graphical information dashboard displays that can quickly be used to assess wellness and PPE compliance across a community of persons being monitored through wearable PPE items. The dashboard displays may be accessed via an Internet portal established by a smart phone device or another computing device (e.g., a tablet device or a notebook/laptop computer) as desired. Alerts and notifications may be presented to such devices via any form or medium desired in an active or passive alert (e.g., email, SMS text notification, voice message, push notification, etc.). In some cases, analysis of data to generate notification and alerts could be made on the service side instead of by PPE devices 104.

While two PPE devices 104 and one gateway device 108 are shown, the system is scalable to include any number of PPE devices 104 and gateway devices 108 distributed about a monitored area. In contemplated embodiments the PPE devices 104 provide data and information in more or less real time to the gateway device(s) 108 present. In other embodiments, however, the data can be collected and stored and communicated to the gateway device 108 in a batch process. In some cases, the PPE devices 104 may include a connector port facilitating data transmission to the gateway 108 via a connected cable. In some embodiments the PPE devices 104 may communicate with a smart phone device that in turn may communicate with the gateway device 108 or directly communicate with the database 106 (and/or database server). Since some hazardous locations do not permit smart phone devices, however, the architecture illustrated does not depend on smart phone devices.

Having described devices and applicable operating algorithms functionally per the description above, those in the art may accordingly implement the algorithms via programming of the controllers or other processor-based devices. Such programming or implementation of the concepts described is believed to be within the purview of those in the art and will not be described further. While an exemplary architecture has been described, variations are possible and the system architecture set forth is made for the purposes of illustration rather than limitation.

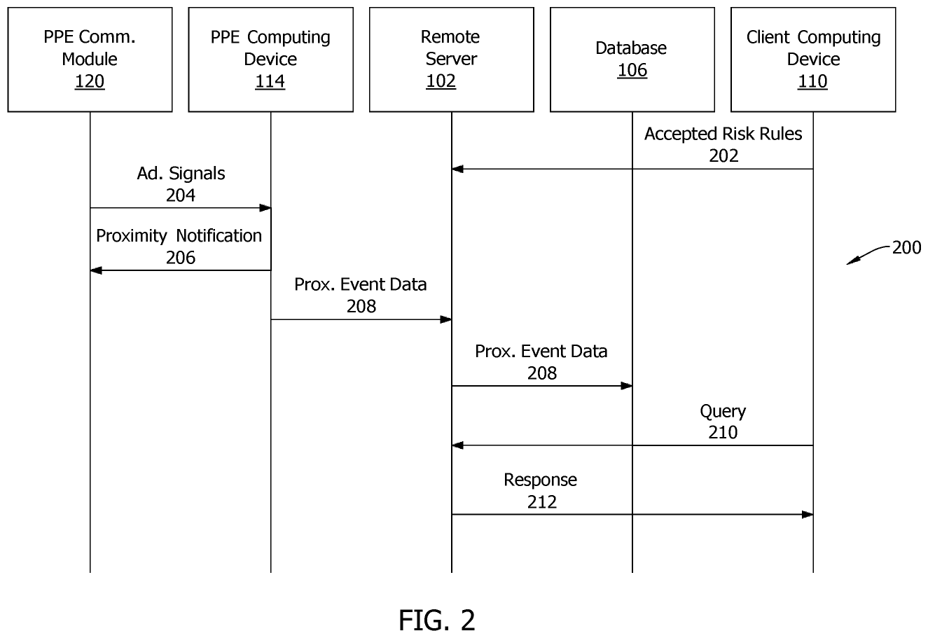

FIG. 2 illustrates a flow chart of an exemplary process 200 for determining proximity events within the system 100 shown in FIG. 1.

In the exemplary embodiment, the remote server 102 receives accepted risk rules 202 from the client computing device 110. Accepted risk rules 202 may include predetermined thresholds from the client associated with the client computing device 110 that indicate what the client defines as a proximity event. For example, the accepted risk rules 202 may include (i) a predetermined sampling rate that the signals of the PPE devices 104 shown in FIG. 1 need to be sampled at (e.g., every 30 seconds, every minute, every five minutes, etc.), (ii) a predetermined distance that the PPE devices 104 have to be within for the interaction to be counted as a proximity event (e.g., three feet, six feet, ten feet, twelve feet, etc.), and (iii) a predetermined amount of time the PPE devices 104 have to be within the predetermined distance of each other for the interaction to be counted as a proximity event. In other embodiments, clients do not provide accepted risk rules 202. In these embodiments, the remote server 102 may use standard rules (e.g., as defined by public health organizations like the Center for Disease Control, CDC, or the World Health Organization, WHO).

In some embodiments, the remote server 102 may transmit the accepted risk rules to the PPE devices 104, and more specifically, the computing devices 114 of the PPE devices. In these embodiments, the PPE devices 104 store the rules 202 and use the stored rules 202 to determine whether or not a proximity event has taken place.

The PPE communication module 120 transmits received advertisement signals 204, the advertisement signals 204 received from other PPE devices 104, to the PPE computing device 114. The PPE computing device 114 uses the received advertisement signals 204 to determine whether a proximity event has occurred. Specifically, the PPE computing device 114 uses intensities of the received advertisement signals 204 to determine whether the intensities are above a threshold (e.g., as determined by the accepted risk rules 202). For example, the intensity threshold may be a known intensity of the received advertising signals 204 when the devices transmitting and receiving the advertising signals are six or fewer feet apart from each other. If the intensities are above the threshold, the PPE computing device 114 identifies the interaction between the PPE devices 104 as a proximity event and stores the proximity event in a memory of the PPE computing device 114. If the intensities are below the threshold, the PPE computing device 114 does not identify the interaction between the PPE devices 104 as a proximity event and does not store the data. If there are multiple consecutive proximity events between the PPE device 104 and the other PPE device 104, the separate events may be condensed into one proximity event with a duration of the proximity event attached to the single proximity event.

In some embodiments, the PPE computing device 114 also uses historical signal strength data to determine whether the intensities of the received advertisement signals 204 are above the threshold, as described further herein. The PPE computing device 114 may store areas with environmental effects that affect the propagation, and therefore the intensities, of the received advertisement signals. For example, one area of a workspace may have dense walls and/or shelves that absorb many of the transmitted signals of the PPE devices 104. In these areas, the intensities of the received signals 202 may be lower than the threshold even when the PPE devices 104 are within the distance associated with the threshold. Accordingly, the PPE computing devices 114 may account for the lower signal intensity in these areas and correctly identify the interaction as a proximity event when the users of the PPE devices 104 are in these areas of the workspace.

If the PPE computing device 114 determines that the PPE device 104 is involved with the other PPE device 104, the PPE computing device 114 may transmit a notification 206 to the PPE communications module 120 to alert a wearer of the PPE device 104 to take appropriate action. For example, the notification 206 may be a haptic, sound, light, or message notification, as described further herein.

The PPE computing device 114 locally stores the proximity events and associated data until the PPE computing device 114 is within range of the remote server 102. When the PPE computing device 114 is within range of the remote server 102, the PPE computing device 114 transmits proximity event data 208 to the remote server 102. The proximity event data 208 may include, for example, the date and time of the proximity event, an identifier of the other PPE device 104 involved in the proximity event, an identifier of the wearer of the other PPE device 104, and the signal strength level between the PPE devices 104 involved in the proximity event. The remote server 102 stores the proximity events from the PPE computing device 114 in the database 106.

The client, through client computing device, may generate a query 210 regarding the proximity events associated with a user for a predetermined time period. For example, if a worker becomes infected (e.g., with COVID-19), the client may want to know the other workers who came in contact with the infected worker such that the other workers can take necessary precautions to stop the spread of infections around the workplace. In the exemplary embodiment, the client computing device 110 transmits the query 210 to the database 106. In other embodiments, the client computing device 110 may transmit the query 210 to the remote server 102 first, which may then transmit the query 210 to the database 106. The database 106 may generate a response 212 to the query 210 including all of the proximity events the user was involved in within the predetermined time. To generate the response, the database 106 may perform a look-up of a user identifier associated with the user to determine whether the user was involved in any proximity events. If the user was involved in any proximity events, the response 212 may include the user identifier(s) of the one or more other users involved in the proximity event with the user. The response 212 may be displayed to the client through the client computing device 110. Specifically, the response 212 may be displayed to the client through an application (e.g., application 132) implemented on the client computing device 110.

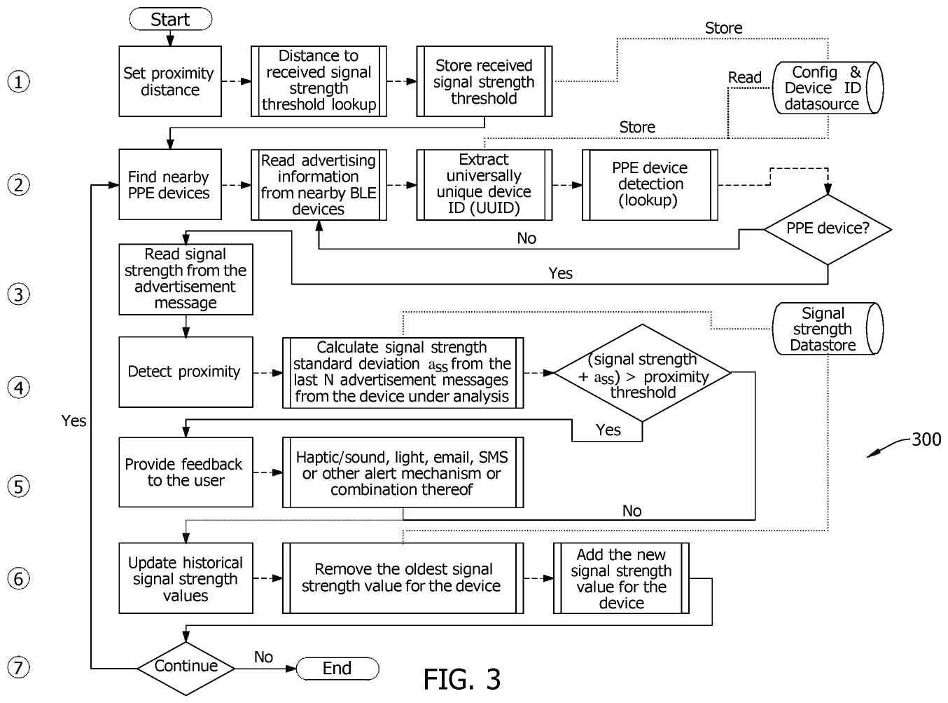

FIG. 3 illustrates a flow diagram illustrating an example process 300 for determining proximity events between PPE devices 104 of the PPE monitoring system 100, both shown in FIG. 1. The process 300 may be implemented by any component of the system 100, including, for example, the PPE computing device 114 and the remote server 102. The process 300 includes steps 1-7, and each step 1-7 includes a multiple of sub-steps.

Step 1 includes setting a proximity distance. In some embodiments, the set proximity distance is included in the accepted risk rules 202 shown in FIG. 2 of the client associated with client computing device 110 shown in FIG. 2. In other embodiments, the set proximity distance is a predetermined distance (e.g., based upon public health establishment rules). Step 1 further includes performing a look-up (e.g., in database 106) to determine the signal strength, also referred to herein as the signal strength intensity, threshold for the received signal (e.g., received advertising signal 204) based upon the set proximity distance. For example, the set proximity distance (e.g., which is in meters, feet, or other distance units) may be converted to a received signal strength value. The received signal strength value may be obtained using values determined from the deployment and/or theoretical model (e.g., inverse-square and/or Friis transmission) formula. In some embodiments, the signal strength threshold may account for different environmental and physical conditions of different areas of the workspace, as described above. The determined signal strength threshold is then stored in a memory (e.g., database 106).

Step 2 includes listening for advertisement messages from nearby devices. For example, the advertisement messages may be from nearby PPE devices 104. When an advertisement message is received, the advertisement message is read to determine whether the advertisement message is a proximity detection advertising message from nearby PPE devices 104. For example, the PPE device 104 may receive advertising messages (e.g., received advertising message 204) from a Bluetooth Low-Energy transceiver of the other PPE devices 104. In other embodiments, the advertising messages may be transmitted and received using Wi-Fi transceivers or RFID. Universally unique device ID (UUID) data is extracted from the received advertising message and stored in a memory (e.g., database 106). A look-up of the memory is performed to determine if the received advertising message is associated with one or more other PPE devices 104. If the received advertising message is associated with another PPE device 104, the process 300 continues to Step 3. If the received advertising message is not associated with another PPE device 104, the process 300 goes back to listening for advertising messages.

Step 3 includes reading signal strength from the received advertising message. The processor (e.g., of PPE computing device 114) of the PPE device 104 determines the received signal strength of the advertisement message. In some embodiments, the processor queries the radio transceiver about the received signal strength of the received advertisement message. In other embodiments, the radio transceiver automatically provides the received signal strength without the processor having to explicitly query the radio transceiver for the received signal strength. The signal strength may be the received power in mW, dBm, uV, or any other figure proportional to the power of the received advertisement signal.

Step 4 includes detecting, from the signal strength of the received advertising signal, the proximity of the other PPE device 104 to the PPE device 104. A standard deviation, a, of the signal strength standard deviation from the last predetermined number, N, of advertisement messages from the other PPE device 104 is calculated. Specifically, the processor (e.g., computing device 114) of the PPE device 104 inspects the signal strength values for the last N advertisement messages received from the other specific PPE device 104, which is identified by its unique ID, and calculates the standard deviation of the last N advertisement messages. Further, it is determined whether the received signal strength combined with the calculated standard deviation of the received signal strength is greater than the proximity threshold. If, and only if, the received signal strength summed to the calculated standard deviation is larger than the predetermined threshold does the processor of the PPE device 104 consider itself to be in “close proximity” to the other PPE device 104. That is, if the received signal strength summed to the calculated standard deviation is larger than the predetermined threshold, the processor determines the PPE device 104 to have a proximity event with the other PPE device 104. The use of the standard deviation reduces false positives and false negative due to the electromagnetic noise in the environment, which may make the signal strength values oscillate widely.

Step 5, which the process 300 proceeds to when the PPE device 104 determines that the PPE device 104 has a proximity event with the other PPE device 104, includes notifying the wearer of the PPE device 104 of the proximity event. The notification may be, for example, a haptic (e.g., vibrating feedback), sound (e.g., buzzer emitting noise), or light (e.g., a flashing LED) notification emitting from the PPE device 104 to alert the wearer of the PPE device 104 to move away from the wearer of the other PPE device 104, or the notification may be an email, SMS, or other alert mechanism, or any combination of notifications thereof.

Step 6 includes updating the historical signal strength values based upon the determination of whether the received signal strength and calculated standard deviation is above the proximity threshold. The oldest signal strength value for the PPE device 104 is removed (e.g., from the memory of the computing device 114), and the new signal strength values for the PPE device 104 is added (e.g., to the memory of the computing device 114).

Step 7 includes continuing the process 300, if necessary, by starting to listen for nearby PPE device 104 signals or ending the process 300. For example, the process 300 may be continued if the wearer of the PPE device 104 is still working and wearing the PPE device 104. The process 300 may be ended if the wearer of the PPE device 104 is no longer working or wearing the PPE device 104.

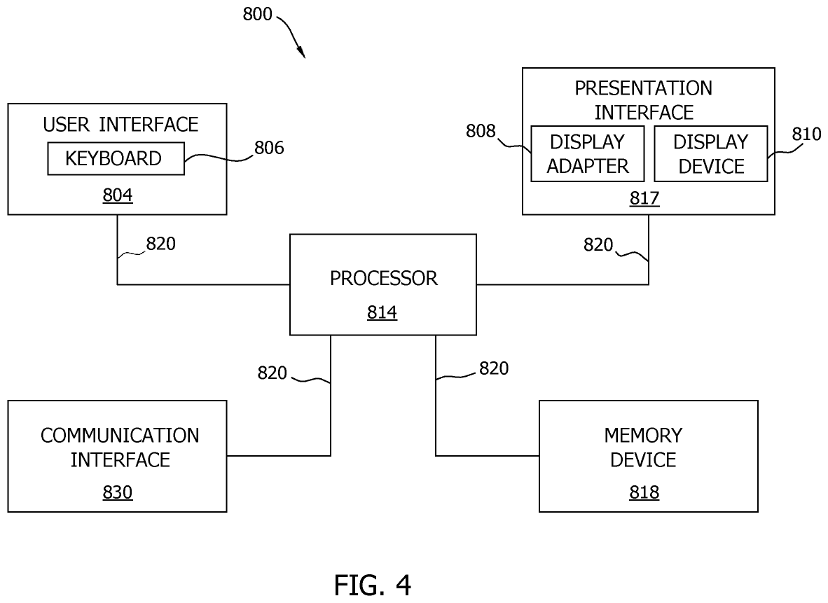

FIG. 4 is a block diagram of an exemplary computing device 800, which may be identical or substantially similar to client computing device 110. In the exemplary embodiment, the computing device 800 includes a user interface 804 that receives at least one input from a user. The user interface 804 may include a keyboard 806 that enables the user to input pertinent information. The user interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the exemplary embodiment, computing device 800 includes a display interface 817 that presents information, such as input events and/or validation results, to the user. The display interface 817 may also include a display adapter 808 that is coupled to at least one display device 810. More specifically, in the exemplary embodiment, the display device 810 may be a visual display device, such as a cathode ray tube (CRT), a liquid crystal display (LCD), a light-emitting diode (LED) display, and/or an “electronic ink” display. Alternatively, the display interface 817 may include an audio output device (e.g., an audio adapter and/or a speaker) and/or a printer.

The computing device 800 also includes a processor 814 and a memory device 818. The processor 814 is coupled to the user interface 804, the display interface 817, and the memory device 818 via a system bus 820. In the exemplary embodiment, the processor 814 communicates with the user, such as by prompting the user via the display interface 817 and/or by receiving user inputs via the user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, the memory device 818 includes one or more devices that enable information, such as executable instructions and/or other data, to be stored and retrieved. Moreover, the memory device 818 includes one or more computer readable media, such as, without limitation, dynamic random access memory (DRAM), static random access memory (SRAM), a solid state disk, and/or a hard disk. In the exemplary embodiment, the memory device 818 stores, without limitation, application source code, application object code, configuration data, additional input events, application states, assertion statements, validation results, and/or any other type of data. The computing device 800, in the exemplary embodiment, may also include a communication interface 830 that is coupled to the processor 814 via the system bus 820. Moreover, the communication interface 830 is communicatively coupled to data acquisition devices.

In the exemplary embodiment, the processor 814 may be programmed by encoding an operation using one or more executable instructions and providing the executable instructions in the memory device 818. In the exemplary embodiment, the processor 814 is programmed to select a plurality of measurements that are received from data acquisition devices.

In operation, a computer executes computer-executable instructions embodied in one or more computer-executable components stored on one or more computer-readable media to implement aspects of the disclosure described and/or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

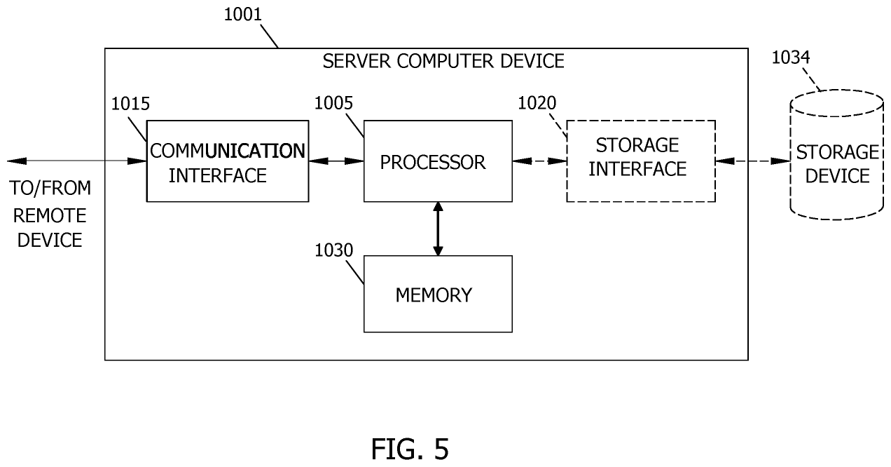

FIG. 5 illustrates an exemplary configuration of a server computer device 1001 such as the gateway 108. The server computer device 1001 also includes a processor 1005 for executing instructions. Instructions may be stored in a memory area 1030, for example. The processor 1005 may include one or more processing units (e.g., in a multi-core configuration).

The processor 1005 is operatively coupled to a communication interface 1015 such that server computer device 1001 is capable of communicating with a remote device such as the PPE monitoring computing device 114, sensors 105, or another server computer device 1001. For example, communication interface 1015 may receive data from the PPE monitoring computing device 114 and the sensors 105, via the Internet.

The processor 1005 may also be operatively coupled to a storage device 1034. The storage device 1034 is any computer-operated hardware suitable for storing and/or retrieving data, such as, but not limited to, wavelength changes, temperatures, and strain. In some embodiments, the storage device 1034 is integrated in the server computer device 1001. For example, the server computer device 1001 may include one or more hard disk drives as the storage device 1034. In other embodiments, the storage device 1034 is external to the server computer device 1001 and may be accessed by a plurality of server computer devices 1001. For example, the storage device 1034 may include multiple storage units such as hard disks and/or solid state disks in a redundant array of inexpensive disks (RAID) configuration. The storage device 1034 may include a storage area network (SAN) and/or a network attached storage (NAS) system.

In some embodiments, the processor 1005 is operatively coupled to the storage device 1034 via a storage interface 1020. The storage interface 1020 is any component capable of providing the processor 1005 with access to the storage device 1034. The storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1005 with access to the storage device 1034.

The benefits and advantages of the inventive concepts are now believed to have been amply illustrated in relation to the exemplary embodiments disclosed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A personal protective equipment device comprising:
a computing device including at least one processor in communication with at least one memory, the at least one processor configured to:
transmit an advertising signal to a plurality of other personal protective equipment devices;
receive advertising signals from the plurality of other personal protective equipment devices when the personal protective equipment device and the plurality of other personal protective devices interact with each other;
determine, based upon an intensity of the received signals, that one of the received signal intensities is above a predetermined threshold;
identify the other personal protective equipment device associated with the received signal above the predetermined threshold;
identify the interaction between the personal protective equipment device and the other personal protective equipment device associated with the received signal above the predetermined threshold as a proximity event;
store the proximity event in the at least one memory; and
transmit the stored proximity event to a server when the personal protective equipment device is within range of a server device.

2. A method of determining proximity events, the method implemented by a computer system of a personal protective equipment device including a computing device including at least one processor in communication with at least one memory, the method comprising:
transmitting an advertising signal to a plurality of other personal protective equipment devices;
receiving advertising signals from the plurality of other personal protective equipment devices when the personal protective equipment device and the plurality of other personal protective devices interact with each other;
determining, based upon an intensity of the received signals, that one of the received signal intensities is above a predetermined threshold;
identifying the other personal protective equipment device associated with the received signal above the predetermined threshold;
identifying the interaction between the personal protective equipment device and the other personal protective equipment device associated with the received signal above the predetermined threshold as a proximity event;
storing the proximity event in the at least one memory; and
transmitting the stored proximity event to a server when the personal protective equipment device is within range of a server device.

3. A personal protective equipment monitoring system including:
a plurality of personal protective equipment devices including a processor in communication with a memory device;
a remote server including a processor in communication with a memory device; and
a client device in communication with the memory device of the remote server,
wherein the processor of the remote server is configured to:
receive, from the processors of the plurality of personal protective equipment devices, a plurality of proximity events between the plurality of personal protective equipment devices;
store the plurality of proximity events in the memory device of the remote server;
receive, from the client computing device, a query to determine the proximity events involving a selected user of one of personal protective equipment devices;
generate, from the memory device of the remote server, a response to the query including each proximity event involving the selected user;
identify, from the response, other users associated with the proximity events involving the selected user; and
transmitting the response and identifications to the client computing device.

4. A method of determining proximity events associated with a user, the method implemented by a personal protective equipment device monitoring system including (i) a plurality of personal protective equipment devices including a processor in communication with a memory device, (ii) a remote server including a processor in communication with a memory device, and (iii) a client device in communication with the memory device of the remote server, the method comprising:
receiving, from the processors of the plurality of personal protective equipment devices by the processor of the remote server, a plurality of proximity events between the plurality of personal protective equipment devices;
storing, by the processor of the remote server, the plurality of proximity events in the memory device of the remote server;
receiving, from the client computing device by the memory device of the remote server, a query to determine the proximity events involving a selected user of one of personal protective equipment devices;
generating, by the memory device of the remote server, a response to the query including each proximity event involving the selected user;
identifying, from the response, other users associated with the proximity events involving the selected user; and
transmitting the response and identifications to the client computing device.
